(19) United States
(12) Patent Application Publication
(10) Pub. No.: US 2026/0093560 A1
(43) Pub. Date: Apr. 2, 2026

(54) ARTIFICIAL INTELLIGENCE POWERED AUTHORING SYSTEM TO CREATE BRIDGE LAYERS FOR ECOSYSTEM APPLICATION PROGRAMMING INTERFACES

(71) Applicant: INTUIT INC., Mountain View, CA (US)

(72) Inventors: Ronnie Douglas DOUTHIT, Trinidad, TX (US); Deepankar MOHAPATRA, Plano, TX (US); Prabhavathi KARAVADI, Frisco, TX (US); Conrad DE PEUTER, Mountain View, CA (US)

(21) Appl. No.: 18/901,537

(22) Filed: Sep. 30, 2024

(51) Int. Cl. G06F 9/54

(52) U.S. Cl. CPC G06F 9/541

(57) ABSTRACT

Aspects of the present disclosure relate to generating bridge artifacts for computing environments. Embodiments include receiving a natural language prompt that indicates a type of bridge artifact to create and a target computing environment. Embodiments further include determining data retrieval tools relevant to the natural language prompt. Embodiments further include invoking the one or more data retrieval tools, wherein the one or more data retrieval tools are configured to retrieve data that is relevant to the natural language prompt and that is associated with the target computing environment. Embodiments further include invoking a bridge artifact creation tool based on the natural language prompt and the data retrieved by the one or more data retrieval tools. Embodiments further include generating a bridge artifact of the type indicated in the natural language prompt.

### INTRODUCTION

Aspects of the present disclosure relate to techniques for generating bridge artifacts for computing environments. In particular, techniques described herein involve using an agent component to identify and invoke various data retrieval tools based on a prompt. The agent component then provides the data retrieved by the data retrieval tools to one or more bridge artifact creation tools that are identified and invoked by the agent component based on the prompt.

### BACKGROUND

Computing systems play an ever-increasing role in modern society. Every year, millions of new computing environments are developed and deployed to address the needs of people, businesses, and organizations around the world. These new computing environments may need to interact with existing computing artifacts to function properly. For example, a new software application may allow users to interact with multiple existing software applications, such as by allowing users to access and modify data within the existing applications.

However, creating a software application that allows users to interact with existing software applications poses significant technical challenges. For example, to construct a user interface application that can interact with multiple different application programming interfaces (APIs), a software developer would need to create custom code (also known as a bridge artifact) for each API, which may require the developer to have extensive knowledge relating to each API. Creating such custom code can be a tedious process that can cause significant delays in software development.

Thus, there is a need in the art for improved techniques of generating bridge artifacts for computing environments.

### BRIEF SUMMARY

Certain embodiments provide a method of generating bridge artifacts for computing environments. The method generally includes: receiving, by an agent component, a natural language prompt that indicates a type of bridge artifact to create and a target computing environment; determining, by the agent component based on providing the natural language prompt as an input to a machine learning model, one or more data retrieval tools relevant to the natural language prompt; invoking, by the agent component, the one or more data retrieval tools, wherein the one or more data retrieval tools are configured to retrieve data that is relevant to the natural language prompt and that is associated with the target computing environment; invoking, by the agent component, a bridge artifact creation tool based on the natural language prompt and the data retrieved by the one or more data retrieval tools; and generating, by the bridge artifact creation tool based on the retrieved data, a bridge artifact of the type indicated in the natural language prompt.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to generating bridge artifacts for computing environments.

FIG. 2 depicts an additional example of computing components related to generating bridge artifacts for computing environments.

FIG. 3 depicts example use cases involving bridge artifacts created according to techniques disclosed herein.

FIG. 4 depicts example operations related to generating bridge artifacts for computing environments.

FIG. 5 depicts an example of a processing system for generating bridge artifacts for computing environments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating bridge artifacts for computing environments.

One technique for automatically generating a bridge artifact may involve use of a generative machine learning model. However, a generative machine learning model as known in the art may not be equipped with information that is required to generate a bridge artifact for a particular computing environment. Also, even if a machine learning model as known in the art is adequately trained and provided with all of the necessary information for generating a particular type of bridge artifact for a particular environment, such a machine learning model may only be able to generate artifacts of the particular type and/or for the particular environment. Thus, using conventional techniques, it is impossible to automatically generate multiple different types of bridge artifacts for multiple different computing environments through a single endpoint.

To address these challenges, according to certain embodiments of the present disclosure, a machine-learning powered agent component may be configured to generate a bridge artifact that facilitates interactions with a target computing environment. A bridge artifact may be a software artifact (e.g., computer code) that allows a given computing environment to interact with a target computing environment. The agent component may create a bridge artifact by invoking data retrieval tools (e.g., identified with the assistance of one or more machine learning models) and artifact creation tools (e.g., which may include one or more generative machine learning models) based on a prompt that indicates a type of bridge artifact to create. The prompt may be a natural language prompt provided by a user that states a desired purpose and a target computing environment. For example, the prompt may instruct the agent component to create a bridge artifact that can allow the user to query a particular type of information from the target computing environment. Based on this prompt, the agent component may invoke a data retrieval tool (e.g., which the agent component may identify as relevant based on providing the prompt to a language processing machine learning model) to gather information that may be required for generating the bridge artifact. This information may be provided to an artifact creation tool, such as a generative machine learning model, that is configured to automatically generate a particular type of artifact that can perform the desired function. In some embodiments, the bridge artifact, once automatically generated, may allow an artificial intelligence-based system to interact with the target computing environment. For example, the target environment may comprise an application programming interface (API), and the bridge artifact may expose the API to a machine learning-based tool.

Embodiments of the present disclosure provide numerous technical and practical effects and benefits. For example, techniques described herein allow for automatically generating bridge artifacts in a dynamic and accurate manner based on user-provided prompts. Additionally, because embodiments of the present disclosure allow for orchestration between multiple knowledge tools and multiple artifact creation tools, multiple types of bridge artifacts may be created for multiple target computing environments via a single endpoint. Creating multiple types of bridge artifacts for multiple target computing environments via a single endpoint was not possible using existing techniques for automated software generation. Alternative techniques may require users to select and deploy separate generative machine learning models for each type of artifact and/or each type of target environment. Also, alternative generative systems may have required retraining and/or rebuilding a machine learning model in response to any changes made to a target computing environment. For example, if a conventional machine learning model was trained to generate a bridge artifact for a given target computing environment, the machine learning model may need to be retrained if changes are made to the given target environment. By contrast, embodiments disclosed herein utilize tools that can automatically retrieve relevant (e.g., up-to-date) information and automatically generate artifacts based on the retrieved information (e.g., providing the retrieved information as context to a generative machine learning model), thereby overcoming the technical challenge posed by the fact that generative machine learning models as known in the art may not be equipped with information that is required to generate a bridge artifact for a particular computing environment. Thus, as long as the knowledge sources from which the knowledge tools retrieve information include relevant information and/or are updated, embodiments of the present disclosure may accurately generate bridge artifacts for a computing environment (e.g., even a recently updated computing environment) without the need for fine-tuning or retraining a machine learning model.

### Example of Computing Components Related to Generating Bridge Artifacts for Computing Environments

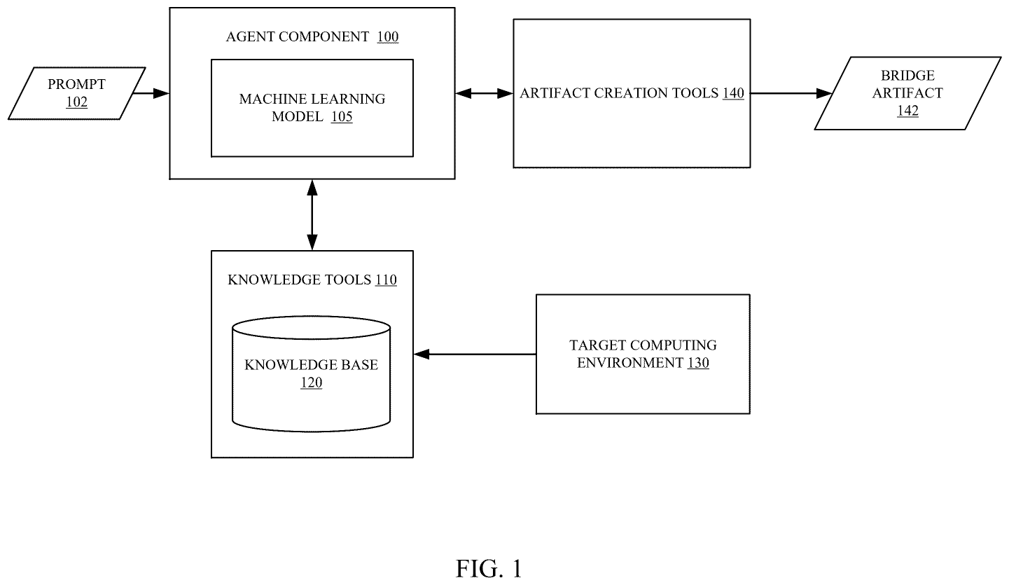

FIG. 1 depicts an example of computing components related to generating bridge artifacts for computing environments.

A user may provide a prompt 102 to an agent component 100. The prompt 102 may comprise natural language instructions to create a bridge artifact 142. The prompt 102 may include an indication of a type of bridge artifact 142 to be created. For example, the type may comprise source code, a function, a tool (e.g., an artificial intelligence-based tool), an application programming interface (API) client, a file, and/or the like. The prompt 102 may include an indication of a target computing environment 130. As discussed in further detail below, the bridge artifact 142 that is to be created may allow for interacting with the target computing environment 130. For example, the target computing environment 142 may be a given API. The bridge artifact 142 may expose the API, thus allowing the user to access the given API through a computing environment that is not natively configured to access the API. The prompt 102 may include an indication of a desired purpose. For example, the purpose may be to allow the user to retrieve a specific type of information. Based on a prompt that includes such a purpose, a bridge artifact that allows the user to retrieve the information may be generated; the target computing environment in this example may be the computing environment that contains the information, and the type of artifact may be an artifact that is capable of retrieving the information (e.g., source code/configuration files for an API client).

To create a bridge artifact 142, the agent component 100 may invoke one or more knowledge tools 110. The agent component 100 may comprise a machine learning model 105 or, alternatively, machine learning model 105 may be separate from agent component 100 and agent component 100 may interact with machine learning model 105. Machine learning model 105 may be any type of machine learning model, such as a neural network, that is trained to determine knowledge tools 110 and/or artifact creation tools 140 relevant to creating a bridge artifact. In one example, machine learning model 105 is a language processing machine learning model such as a large language model (LLM) that is trained more generally on natural language data, and is able to identify knowledge tools 110 and/or artifact creation tools 140 relevant to creating a bridge artifact based on being provided with a natural language prompt along with a list of possible knowledge tools 110 and/or artifact creation tools 140 from which to select (e.g., including attributes and/or descriptions associated with such tools as inputs to the model).

The agent component 100 may invoke a knowledge tool 110 based on a description associated with the knowledge tool 110. For example, each knowledge tool 110 may be associated with a natural language description that describes the function of the knowledge tool 110. Based on such descriptions, the machine learning model 105 may be able to identify and output indications of one or more knowledge tools 110 that are relevant for generating a given bridge artifact 142 (e.g., based on being provided with prompt 102 and the descriptions of knowledge tools 110), and the agent component 100 may invoke the identified one or more knowledge tools 110.

Knowledge tools 110 may generally comprise any type of computing tool that is capable of retrieving information. Examples of knowledge tools 110 include a tool that is capable of retrieving information from a database (e.g., a database may contain developer documentation associated with a target computing environment 130), a tool that is capable of retrieving an API specification, a machine learning-based tool that is trained to determine which type of information to retrieve based on a prompt, and/or the like. A knowledge tool 110 may be configured to search a database or a set of API specifications to identify information that is relevant to the prompt 102. For example, the knowledge tool may search embedding representations of documents contained within a database. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities.

A knowledge tool 110 may identify items such as documents or API specifications and extract relevant data from the items. For example, the knowledge tool 110 may be configured to interpret an API specification and identify parameters that may be passed through or received from the API. As another example, a knowledge tool 110 may interact with a computing environment (e.g., by providing an input to the computing environment), and retrieve information based on the interaction (e.g., information that is returned based on the interaction). Any data that a knowledge tool 110 extracts may be provided to agent component 100 and used to generate the bridge artifact 142.

In some embodiments, a knowledge tool 110 may be used to identify the target computing environment 130. For example, a prompt 102 may indicate a goal, such as retrieving a particular type of information. The knowledge tools 110 may retrieve data associated with multiple computing environments. This data may be used to identify a computing environment that is capable of providing the particular type of information (e.g., an API that returns the particular type of information or includes an input parameter relevant to the particular type of information). As an example, different knowledge tools 110 may retrieve specifications for different APIs. The knowledge tool(s) 110 and/or machine learning model 105 may interpret the specifications and determine the information that each API is capable of returning. Based on the determination, an API that returns the particular type of information may be identified as the target computing environment 130.

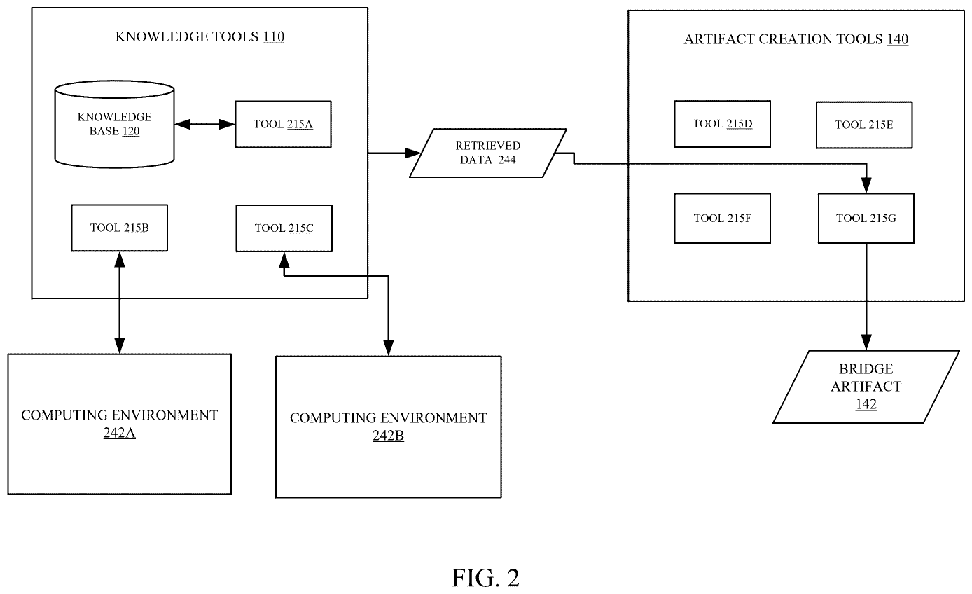

As discussed in further detail below with respect to FIG. 2, the knowledge tools 110 may include tools that are capable of retrieving data from a knowledge base 120. The knowledge base 120 may be a locally-stored database that contains data associated with various computing environments, such as target computing environment 130. The knowledge tools 110 may also include tools that are capable of retrieving data from the target computing environment 130 as well as other computing environments, and/or from sources such as the Internet. For example, a tool may retrieve data from a database associated with target computing environment 130.

The target computing environment 130 may be generally any type of computing environment or computing component. For example, the target computing environment 130 may be a component (e.g., an API or a microservice) of a larger computing environment such as a domain.

To create a bridge artifact 142, the agent component 100 may invoke one or more artifact creation tools 140. The agent component 100 may invoke an artifact creation tool 140 based on a description associated with the artifact creation tool 140. For example, an artifact creation tool 140 may be associated with a natural language description that describes the function of the artifact creation tool 140. Based on such descriptions, machine learning model 105 may be able to identify and output indications of artifact creation tools 140 that are relevant for generating a given bridge artifact 142 (e.g., based on being provided with prompt 102 and the descriptions of artifact creation tools 140). Such identification may also be based on the data retrieved by the knowledge tools 110 (e.g., which may also be provided to machine learning model 105). For example, the retrieved data may indicate a target computing environment 130. An artifact creation tool 140 that is configured to generate a software artifact for the target computing environment 130 may be identified and output by machine learning model 105 and invoked by the agent component 100 based on such an output.

Artifact creation tools 140 may generally comprise any type of computing tool that is capable of generating a software artifact. For example, an artifact creation tool 140 may comprise a machine learning model that is trained and/or otherwise configured to generate a specific type of software artifact and/or that is trained more generally as a generative machine learning model. A given artifact creation tool 140 may generate the specific type of software artifact based on a template corresponding to the specific type of software artifact. For example, the template may comprise a generic version of a software artifact, and the artifact creation tool 140 may create a version of the artifact that is tailored to a specific goal and/or a specific computing environment (e.g., based on being provided with and/or otherwise retrieving the template and information about the specific goal and/or specific computing environment, such as being provided with prompt 102 and/or information derived from prompt 102).

Different types of artifact creation tools 140 may be used to create different types of bridge artifacts 142. For example, a first artifact creation tool 140 may create configuration files, while another artifact creation tool 140 may create source code for clients, artificial intelligence agents, functions, and/or the like. In other embodiments, a single artifact creation tool 140 is able to create multiple types of bridge artifacts.

The bridge artifact 142 may generally be any type of software artifact, such as a configuration file, function, API client, artificial intelligence agent, software tool, and/or the like. The bridge artifact 142 may allow a user to interact with the target computing environment 130 via a computing environment that is not natively configured to interact with the target computing environment 130. In some embodiments, the bridge artifact 142 may allow a machine learning model to interact with the target computing environment 130. For example, the bridge artifact may comprise a first software artifact that is an API client, and a second software artifact that enables a machine learning model to use the API client. One or more bridge artifacts 142 may constitute a bridge layer that allows a component such as a machine learning model to dynamically discover what ecosystem APIs exist for one or more existing computing environments, when it would be appropriate to call those APIs, the syntax of those APIs, and any authorization and/or authentication mechanisms that are applicable.

Artifact creation tools 140 may create bridge artifacts 142 based on information retrieved by the knowledge tools 110. For example, a knowledge tool 110 may retrieve data indicating the parameters that may be passed to an API. Based on this data, an API client may be generated that can pass each of the parameters to the API.

The bridge artifact generation system may be updated by updating the data sources used by the knowledge tools 110. For example, a given API may be updated. If the documentation of this API is also updated (e.g., by uploading updated documentation to a database used by a knowledge tool 110), a bridge artifact 142 may be created based on the updated version of the API (e.g., because the bridge artifacts 142 may be created based on data retrieved by knowledge tools 110). Thus, embodiments discussed herein allow for updating a bridge artifact generation system without retraining a machine learning model.

FIG. 2 depicts an additional example of computing components related to generating bridge artifacts for computing environments.

The knowledge tools 110 may contain a plurality of tools 215A-C that are configured to extract data from one or more sources. As shown in FIG. 2, tool 215A is a tool that is configured to extract data from a locally-stored knowledge base 120. The knowledge base 120 may be a database that contains data associated with one or more computing environments. For example, the knowledge base 120 may include data that was previously extracted by other tools 215. The knowledge base 120 may contain data relating to a user's computing environment. This data may be used to generate a bridge artifact 142 that allows the user's computing environment to interact with a target environment. For example, the user may want to generate a bridge artifact 142 that allows a machine learning model in the user's computing environment to interact with a target microservice. The knowledge base may include data associated with the machine learning model that is relevant to generating the bridge artifact 142.

As shown in FIG. 2, tool 215B is a tool that is configured to extract data associated with computing environment 242A. The data may be data that is stored in a database associated with computing environment 242A. The data may comprise developer documentation written by developers of computing environment 242A, a specification for a target API, and/or the like. Tool 215B may be a tool that extracts information from computing environment 242A by interacting with computing environment 242A (e.g., by submitting an input to computing environment 242A and analyzing the output received in response to the input or providing the output to a machine learning model such as machine learning model 105 of FIG. 1). Tool 215C may comprise a similar tool that is configured to extract data associated with computing environment 242B. The data extracted by the tools 215 may be used to determine which computing environment 242 is the target computing environment. For example, a prompt submitted by a user may request a bridge artifact that is capable of querying a given type of information. The data extracted using tool 215B may indicate that the given type of information may be passed as a parameter by or returned by computing environment 242A. The data extracted using tool 215C may indicate that the given type of information is not passed as a parameter by or returned by computing environment 242B. Thus, computing environment 242A may be selected as the target computing environment, and a bridge artifact 142 may be generated that allows for interacting with computing environment 242A. If an additional tool was configured to extract data associated with a source that does not involve querying information, then this tool may not be invoked (e.g., because a description associated with the tool may enable an agent component to determine that the tool is not relevant to the user prompt).

In some embodiments, one or more of tools 215A-C are machine learning-based tools that are trained to extract data. For example, a tool 215 may comprise a machine learning model that is trained to understand embedding representations of data contained within a database and identify data that is relevant to a user prompt. In other embodiments, one or more of tools 215A-C may be tools other than machine learning models. For example, tool 215A may be a data parser that parses data within knowledge base 120 to retrieve data that an agent component (as discussed in FIG. 1) determines to be relevant based on a user prompt.

The artifact creation tools 140 may comprise one or more tools 215D-G that are configured to generate bridge artifacts. Data retrieved by the knowledge tools 110 (hereinafter referred to as retrieved data 244) may be provided to one or more of the artifact creation tools 140 such as by an agent component. The agent component may only provide the retrieved data 244 to tool(s) that the agent component determines to be relevant - other tools may not be invoked. For example, a prompt submitted by a user may request a bridge artifact that is capable of querying a given type of information. A target computing environment may be identified based on using one or more of the knowledge tools 110, and data associated with the target computing environment may be retrieved using one or more of the knowledge tools 110. The retrieved data 244 may be provided to a tool that is configured to generate a bridge artifact 142 corresponding to the target computing environment. For example, tool 215G may be a tool that is configured to generate an API client for an API that was identified as the target API. Based on a description associated with tool 215G, an agent component may invoke tool 215G and provide the retrieved data 244 as input to tool 215G (e.g., along with a prompt or other input requesting the generation of bridge artifact 142). Tools 215D-F may be tools that are not relevant to the user prompt and may not be invoked. For example, tool 215D may generate a configuration file that is not related to the API client, and tools 215E may generate API clients for a different APIs.

In some embodiments an artifact creation tool 140 may comprise a machine learning model that is trained to generate a certain type of bridge artifact or to generate content more generally. Such a machine learning model may be trained through a supervised learning process. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and/or the like. In some embodiments, validation and testing are also performed for a machine learning model, such as based on validation data and test data, as is known in the art.

Each of tools 215D-G may be configured to generate a specific type of bridge artifact. The type may be based on a type of target computing environment. The type may be based on a computing environment that is to interact with the target computing environment. Furthermore, the type may be based on the combination of target computing environment and computing environment that is to interact with the target computing environment. For example, a user may wish to create a bridge artifact that allows a machine learning tool to interact with an API. A type of bridge artifact may allow a machine learning tool to interact with an API (e.g., the bridge artifact may be a function that is configured to be called by a machine learning tool; when called by the machine learning tool, the function may run a query using the API). Bridge artifact types may include configuration files, source code (e.g., for functions, artificial intelligence agents, API clients, plugins, etc.) and/or the like.

The artifact creation tools 140 may generate bridge artifacts based on templates of the bridge artifacts. For example, in addition to being provided with the retrieved data 244, tool 215G may also be provided with a template of an API client. Tool 215G may generate a bridge artifact 142 that is similar to the API client template but is customized based on the retrieved data 244. For example, the custom API client may be configured to be accessed by the user's computing environment based on the retrieved data 244 (e.g., the API client may be configured to be invoked by a machine learning tool within the user's computing environment).

### Example Use Cases Involving Bridge Artifacts Created According to Techniques Disclosed Herein

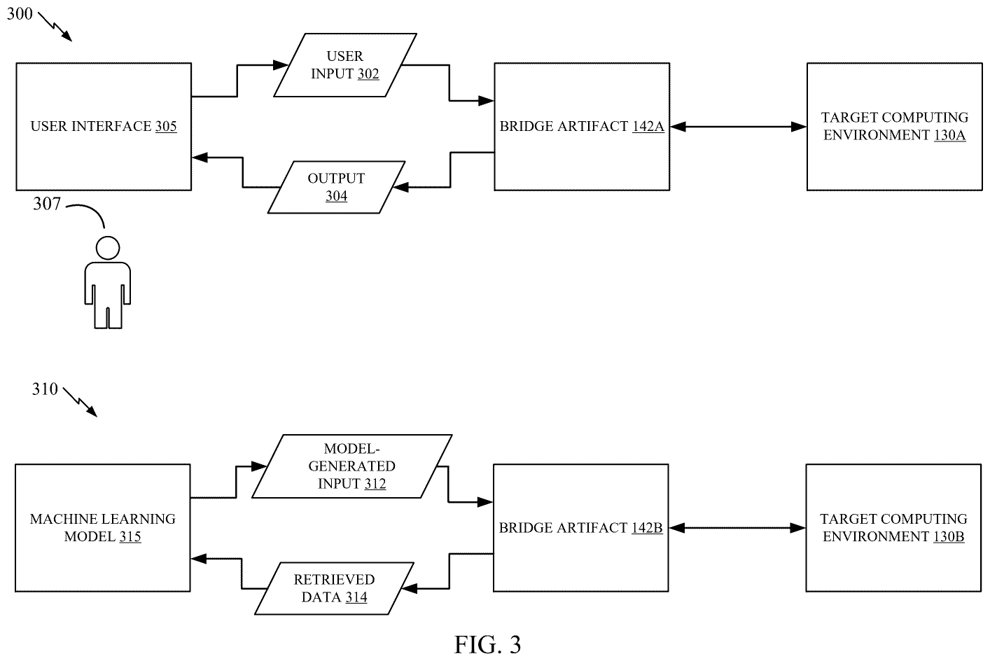

FIG. 3 depicts example use cases involving bridge artifacts created according to techniques disclosed herein. The bridge artifacts 142A-B may be generated using computing components described above with respect to FIG. 1 and FIG. 2.

Use case 300 involves a bridge artifact 142A that is configured to act as an interface between a software application associated with a user interface 305 and a target computing environment 130A. For example, user 307 may be able to interact with the software application via user interface 305. Target computing environment 130A may be a microservice that the software application is not natively configured to access. A bridge artifact 142A may be created that allows the user 307 to interact with the target computing environment 130A through the user interface 305. For example, the bridge artifact 142A may be source code for a plugin that allows the user 307 to access the target computing environment 130A directly through the user interface 305. The user 307 may provide user input 302 to the user interface 305, and the user input 302 may be provided to the bridge artifact 142A. The bridge artifact 142A may perform one or more actions relating to the target computing environment 130A based on the user input, and the bridge artifact 142A may return an output 304 to the user interface 305 from the target computing environment 130A.

Use case 310 involves a bridge artifact 142B that is configured to act as an interface between a machine learning model 315 and a target computing environment 130B. For example, the target computing environment 130B may be an application programming interface (API), and the machine learning model 315 may not be natively configured to interact with the target computing environment 130B. A bridge artifact 142A may be created that allows the machine learning model 315 to interact with the target computing environment 130B. For example, the bridge artifact 142B may be an API client that is configured to be invoked by the machine learning model 315 (or an agent associated with machine learning model 315) and retrieve data that is indicated by the machine learning model 315. The machine learning model 315 or an associated agent may invoke the bridge artifact 142B and provide the bridge artifact 142B with a model-generated input 312 that indicates which data the client should retrieve using the API/target computing environment 130B. The bridge artifact 142B may receive the data from the API and provide this retrieved data 314 to the machine learning model 315 or the associated agent (e.g., which may provide the retrieved data 314 to the machine learning model 315 or another component).

In some embodiments, a bridge artifact 142 may comprise multiple software artifacts. For example, bridge artifact 142A may comprise a first software artifact that is an API client and a second software artifact that is an artificial intelligence agent that can receive a user prompt and invoke the API client based on the prompt.

### Example Operations Related to Generating Bridge Artifacts for Computing Environments

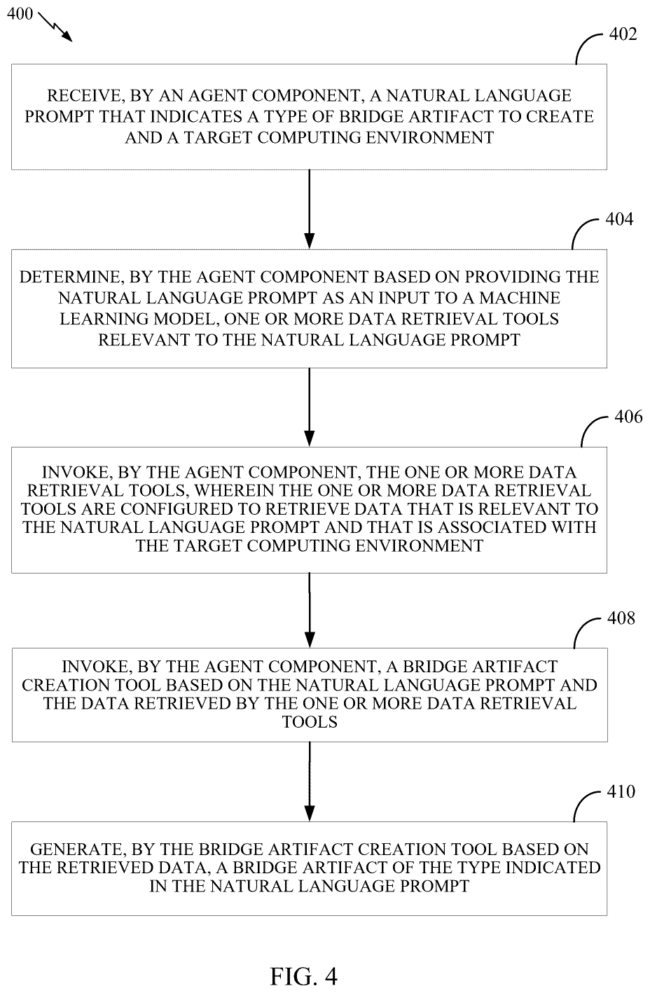

FIG. 4 depicts example operations 400 related to generating bridge artifacts for computing environments. For example, operations 400 may be performed by one or more of the components described with respect to FIG. 1 and FIG. 2.

Operations 400 begin at step 402 with receiving, by an agent component, a natural language prompt that indicates a type of bridge artifact to create and a target computing environment. Some embodiments provide that the type indicated in the natural language prompt comprises source code for a software artifact.

Operations 400 continue at step 404 with determining, by the agent component based on providing the natural language prompt as an input to a machine learning model, one or more data retrieval tools relevant to the natural language prompt. In some embodiments, wherein the target computing environment comprises an application programming interface (API), wherein a particular data retrieval tool of the one or more data retrieval tools is configured to retrieve data based on the API.

Operations 400 continue at step 406 with invoking, by the agent component, the one or more data retrieval tools, wherein the one or more data retrieval tools are configured to retrieve data that is relevant to the natural language prompt and that is associated with the target computing environment. In certain embodiments, the one or more data tools are used to identify the target computing environment. Certain embodiments provide that determining the one or more data retrieval tools relevant to the natural language prompt is based on a descriptor associated with a given data retrieval tool that enables the machine learning model to identify the given data retrieval tool as being relevant to the natural language prompt. Some embodiments provide that a particular data retrieval tool of the one or more data retrieval tools is configured to retrieve documentation associated with the target computing environment. In certain embodiments, a particular data retrieval tool of the one or more data retrieval tools comprises an additional machine learning model that is trained to retrieve data associated with the target computing environment.

Operations 400 continue at step 408 with invoking, by the agent component, a bridge artifact creation tool based on the natural language prompt and the data retrieved by the one or more data retrieval tools. Certain embodiments provide that invoking the bridge artifact creation tool is based on a descriptor associated with the bridge artifact creation tool that enables the agent component to identify the bridge artifact creation tool as being relevant to the natural language prompt. According to some embodiments, the bridge artifact creation tool comprises a generative machine learning model that is trained to generate bridge artifacts of the type indicated in the natural language prompt.

Operations 400 continue at step 410 with generating, by the bridge artifact creation tool based on the retrieved data, a bridge artifact of the type indicated in the natural language prompt. Certain embodiments provide that the bridge artifact comprises a first software artifact that is configured to interact with the target computing environment and a second software artifact that interacts with the first software artifact based on user input. In some embodiments, the generating is further based on a bridge artifact template, wherein the bridge artifact template corresponds to the type indicated in the natural language prompt.

### Example of a Processing System for Generating Bridge Artifacts for Computing Environments

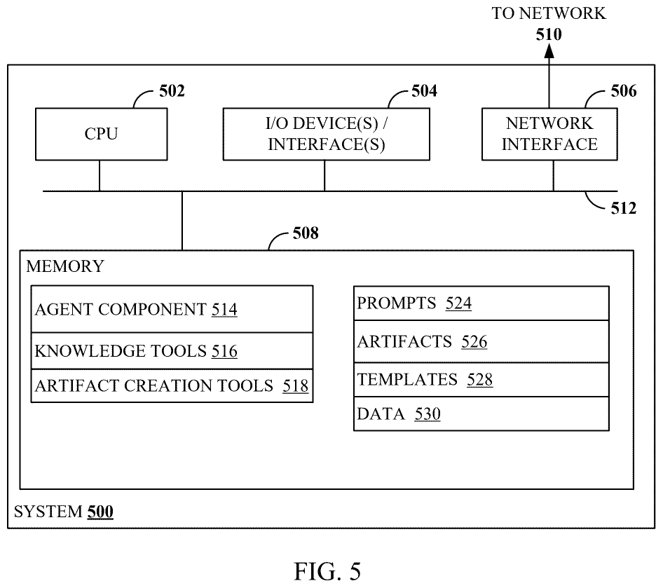

FIG. 5 illustrates an example system 500 with which embodiments of the present disclosure may be implemented. For example, system 500 may be configured to perform operations 400 of FIG. 4 and/or to implement one or more components as in FIG. 1 or FIG. 2.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes orchestration agent component 514, knowledge tools 516, and artifact creation tools 518. Agent component 514 may be representative of agent component 100 of FIG. 1. In some embodiments, knowledge tools 516 may be representative of knowledge tools 110 of FIG. 1 and FIG. 2. Artifact creation tools 518 may be representative of artifact creation tools 140 of FIG. 1 and FIG. 2.

Memory 508 further comprises prompts 524, which may correspond to prompt 102 of FIG. 1. Memory 508 further comprises artifacts 526 which may correspond to bridge artifact 142 of FIG. 1, FIG. 2, or FIG. 3. Memory 508 further comprises templates 528, which may include templates used by bridge creation tools to create software artifacts. Memory 508 further comprises data 530, which may correspond to data retrieved by the knowledge tools 110 of FIG. 1 and FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of generating bridge artifacts for computing environments, comprising:
receiving, by an agent component, a natural language prompt that indicates a type of bridge artifact to create and a target computing environment;
determining, by the agent component based on providing the natural language prompt as an input to a machine learning model, one or more data retrieval tools relevant to the natural language prompt;
invoking, by the agent component, the one or more data retrieval tools, wherein the one or more data retrieval tools are configured to retrieve data that is relevant to the natural language prompt and that is associated with the target computing environment;
invoking, by the agent component, a bridge artifact creation tool based on the natural language prompt and the data retrieved by the one or more data retrieval tools; and
generating, by the bridge artifact creation tool based on the retrieved data, a bridge artifact of the type indicated in the natural language prompt.

2. The method of claim 1, further comprising using the one or more data retrieval tools to identify the target computing environment.

3. The method of claim 1, wherein determining the one or more data retrieval tools relevant to the natural language prompt is based on a descriptor associated with a given data retrieval tool that enables the machine learning model to identify the given data retrieval tool as being relevant to the natural language prompt.

4. The method of claim 1, wherein the target computing environment comprises an application programming interface (API), wherein a particular data retrieval tool of the one or more data retrieval tools is configured to retrieve data based on the API.

5. The method of claim 1, wherein a particular data retrieval tool of the one or more data retrieval tools is configured to retrieve documentation associated with the target computing environment.

6. The method of claim 1, wherein a particular data retrieval tool of the one or more data retrieval tools comprises an additional machine learning model that is trained to retrieve data associated with the target computing environment.

7. The method of claim 1, wherein invoking the bridge artifact creation tool is based on a descriptor associated with the bridge artifact creation tool that enables the agent component to identify the bridge artifact creation tool as being relevant to the natural language prompt.

8. The method of claim 1, wherein the bridge artifact creation tool comprises a generative machine learning model that is trained to generate bridge artifacts of the type indicated in the natural language prompt.

9. The method of claim 1, wherein the type indicated in the natural language prompt comprises source code for a software artifact.

10. The method of claim 1, wherein the bridge artifact comprises a first software artifact that is configured to interact with the target computing environment and a second software artifact that interacts with the first software artifact based on user input.

11. The method of claim 1, wherein the generating is further based on a bridge artifact template, wherein the bridge artifact template corresponds to the type indicated in the natural language prompt.

12. A system for generating bridge artifacts for computing environments, comprising:
one or more processors; and
a memory comprising instructions that, when executed by the one or more processors, cause the system to:
receive, by an agent component, a natural language prompt that indicates a type of bridge artifact to create and a target computing environment;
determine, by the agent component based on providing the natural language prompt as an input to a machine learning model, one or more data retrieval tools relevant to the natural language prompt;
invoke, by the agent component, the one or more data retrieval tools, wherein the one or more data retrieval tools are configured to retrieve data that is relevant to the natural language prompt and that is associated with the target computing environment;
invoke, by the agent component, a bridge artifact creation tool based on the natural language prompt and the data retrieved by the one or more data retrieval tools; and
generate, by the bridge artifact creation tool based on the retrieved data, a bridge artifact of the type indicated in the natural language prompt.

13. The system of claim 1, wherein the memory further causes the system to use the one or more data retrieval tools to identify the target computing environment.

14. The method of claim 1, wherein determining the one or more data retrieval tools relevant to the natural language prompt is based on a descriptor associated with a given data retrieval tool that enables the machine learning model to identify the given data retrieval tool as being relevant to the natural language prompt.

15. The method of claim 1, wherein the target computing environment comprises an application programming interface (API), wherein a particular data retrieval tool of the one or more data retrieval tools is configured to retrieve data based on the API.

16. The system of claim 12, wherein a particular data retrieval tool of the one or more data retrieval tools is configured to retrieve documentation associated with the target computing environment.

17. The system of claim 12, wherein a particular data retrieval tool of the one or more data retrieval tools comprises an additional machine learning model that is trained to retrieve data associated with the target computing environment.

18. The method of claim 1, wherein invoking the bridge artifact creation tool is based on a descriptor associated with the bridge artifact creation tool that enables the agent component to identify the bridge artifact creation tool as being relevant to the natural language prompt.

19. The method of claim 1, wherein the bridge artifact creation tool comprises a generative machine learning model that is trained to generate bridge artifacts of the type indicated in the natural language prompt.

20. The system of claim 12, wherein the bridge artifact comprises a first software artifact that is configured to interact with the target computing environment and a second software artifact that interacts with the first software artifact based on user input.
